(19) United States
(12) Patent Application Publication
(10) Pub. No.: US 2014/0045383 A1
(43) Pub. Date: Feb. 13, 2014

(54) CONNECTOR

(71) Applicant: KYOCERA CONNECTOR PRODUCTS CORPORATION, KANAGAWA (JP)

(72) Inventor: YOSHIHARU FUJII, KANAGAWA (JP)

(73) Assignee: KYOCERA CONNECTOR PRODUCTS CORPORATION, KANAGAWA (JP)

(21) Appl. No.: 13/957,486

(22) Filed: Aug. 2, 2013

(30) Foreign Application Priority Data
Aug. 7, 2012 (JP) 2012174611

(51) Int. Cl. H01R 13/05

(52) U.S. Cl. CPC H01R 13/05
USPC 439/630

(57) ABSTRACT

A connector includes an insulator having a connecting-object insertion groove and at least one contact supported by the insulator to be contactable with a trace of a circuit pattern formed on a connecting object. The contact includes a first resilient deformable portion, a first contact protrusion protruding from the first resilient deformable portion and contacting the trace, a second resilient deformable portion extending toward the innermost end of the connecting-object insertion groove from the first contact protrusion and thereafter extending back toward the first contact protrusion, and a second contact protrusion protruding from the second resilient deformable portion, positioned closer to the innermost end of the connecting-object insertion groove than the first contact protrusion, and contacting a portion of the trace at a position closer to the innermost end than that at which the first contact protrusion contacts.

### CROSS REFERENCE TO RELATED APPLICATION

The present invention is related to and claims priority of the following co-pending application, namely, Japanese Patent Application No. 2012-174611 filed on Aug. 7, 2012, herein incorporated by reference in its entirety.

### FIELD OF THE INVENTION

The present invention relates to a connector capable of being connected to a thin plate-shaped connecting object such as an FPC or FFC.

### BACKGROUND OF THE INVENTION

Japanese Unexamined Patent Publication No. 2010-3590 discloses an example of a connector capable of being connected to a thin plate-shaped connecting object (such as an FPC or FFC). This connector is provided with an insulator mounted on a circuit board and a plurality of contacts arranged and fixed to the insulator. The insulator is provided with an insertion groove into which the connecting object is insertable, and from which the connecting object is removable, and the plurality of contacts are connected to the aforementioned circuit board.

Inserting the connecting object into the insertion groove of the insulator causes a plurality of contact protrusions which respectively protrude from the plurality of contacts to come into contact with a circuit pattern formed on one surface of the connecting object, which establishes electrical continuity between the connecting object and the circuit board via the plurality of contacts.

This type of connector is applicable to various products; for instance, with the computerization of automobiles, it is being proposed to incorporate this type of connector into car navigation systems and meter indicators, etc.

However, since various minute particles (e.g., minute dust particles) are present in the interior of vehicles, minute particles may enter the inside of vehicle-mounted electronic equipment and adhere to conductive contact lands of the circuit pattern of the connecting object. If the contact protrusions of the contacts come in contact with the contact lands of the circuit board with minute dust particles adhered to the contact lands, minute dust particles get caught in between the contact lands and the contact protrusions, which may cause contact failure between the connecting object and the contacts of the connector.

In addition, since the connecting object and the connector are structured such that the connecting object and each contact of the connector comes in contact with each other at a single point (a contact point between the circuit pattern and the contact protrusion of the contact of the connector), there is a possibility of the contact state (contact engagement) between the contacting object and each contact of the connector being temporarily (momentarily) released each time vibrations occur during driving of the vehicle.

As countermeasures against this sort of problem, each contact of the connector can be provided with a first contact protrusion and a second contact protrusion as shown in, e.g., the comparative example shown in FIG. 14. With this structure, the first contact protrusion comes into sliding contact with a contact land (conductor trace) of the circuit pattern of the connecting object and subsequently the second contact protrusion comes into contact with the same contact land when the connecting object is plugged into the connector.

Minute foreign particles adhered to the contact land of the circuit pattern are cleaned (swept off) by the sliding contact of the first contact protrusion with the contact land of the circuit pattern, and subsequently the second contact protrusion comes into contact with this cleaned surface (the same contact land of the circuit pattern), which reduces the possibility of poor electrical contact occurring between the connecting object and each contact of the connector.

Additionally, since the connecting object and each contact of the connector are in contact with each other at two points (a contact point between a contact land of the circuit pattern and the first contact protrusion and another contact point between the same contact land of the circuit pattern and the second contact protrusion), even if the contact state of one of the two contact points is temporarily (momentarily) released by vibrations, there is a possibility of the contact state of the other contact point being maintained, which improves contact reliability.

However, since FPCs and FFCs, for instance, tend to vary in thickness due to problems in manufacturing, sometimes the amount of displacement of the first contact protrusion becomes slightly greater than a predetermined value (design value) when an FPC or FFC is inserted into the insulator of the connector. If the amount of displacement of the first contact protrusion becomes greater than a predetermined value in this manner, the amount of displacement of the second contact protrusion, which is formed continuous with the first contact protrusion, becomes far greater than the predetermined value and the following problems may arise: the spring force of a portion of the contact which is positioned closer to the free end (the second contact protrusion) than the first contact protrusion may decrease, or the second contact protrusion may be spaced from the circuit pattern. In addition, if the position of the second contact protrusion in an initial state is set to be far closer to the connecting object for the purpose of making the second contact protrusion contact the circuit pattern with stability, the following problems may arise: the spring force of a portion of the contact which is positioned closer to the base end (on the opposite side from the second contact protrusion) than the first contact protrusion may decrease, or the first contact protrusion may be spaced from the circuit pattern. Accordingly, it has been extremely difficult to achieve a stable contact state (stable spring force) between the thick connecting object and each contact of the connector by making both the first and second contact protrusions of each contact come into contact securely with the connecting object.

In addition, if a portion of each contact of the connector between the first contact protrusion and the second contact protrusion is lengthened in the insertion direction of the connecting object into the insulator of the connector, the connector increases in size in this insertion direction. However, since there has been a demand for miniaturization of the connector, the size of each contact of the connector in the insertion direction needs to be reduced. To this end, the distance between the first contact protrusion and the second contact protrusion in the insertion direction also needs to be reduced.

### SUMMARY OF THE INVENTION

The present invention provides a connector which can be miniaturized in the insertion direction, of a connecting object into the insulator of the connector, and which makes it possible to achieve a stable contact state even for a connecting object which tends to vary in thickness by making each contact of the connector contact the connecting object securely at two points.

According to an aspect of the present invention, a connector is provided, including an insulator having a connecting-object insertion groove, into which a connecting object having a thin plate shape can be inserted and removed through an open end of the connecting-object insertion groove; and at least one contact which is supported by the insulator to be contactable with a trace of a circuit pattern formed on one side of the connecting object. The contact includes a first resilient deformable portion, a part of which extends toward an innermost end of the connecting-object insertion groove from the open end; a first contact protrusion which protrudes from the first resilient deformable portion and comes into sliding contact with the trace when the connecting object is inserted into the connecting-object insertion groove; a second resilient deformable portion which extends toward the innermost end of the connecting-object insertion groove from the first contact protrusion and thereafter extends back toward the first contact protrusion; and a second contact protrusion which protrudes from the second resilient deformable portion, is positioned closer to the innermost end of the connecting-object insertion groove than the first contact protrusion, and comes into contact with a portion of the trace which is positioned closer to the innermost end of the connecting-object insertion groove than another portion of the trace with which the first contact protrusion is in contact when the connecting object is inserted into the connecting-object insertion groove.

It is desirable for the contact to include a toward-open-end extended portion which extends toward the open end from the innermost end side, and for the first resilient deformable portion to extend toward the open end from an end of the toward-open-end extended portion and thereafter extend toward the innermost end so as to face the toward-open-end extended portion in a thickness direction of the connecting object.

It is desirable for the second resilient deformable portion to include a first-contact-protrusion end portion which extends toward the toward-open-end extended portion from the first contact protrusion; an intermediate portion which extends toward the innermost end from the first-contact-protrusion end portion and faces the toward-open-end extended portion in the thickness direction of the connecting object; and a turned-back end portion which extends back toward the first contact protrusion from an end of the intermediate portion to face the intermediate portion in the thickness direction of the connecting object, wherein the second contact protrusion protrudes from the turned-back end portion.

It is desirable for the first-contact-protrusion end portion to be greater in rigidity than the first contact protrusion and the intermediate portion.

It is desirable for the first-contact-protrusion end portion to be greater in width than that of the first resilient deformable portion and that of the intermediate portion.

It is desirable for the at least one contact to be a plurality of contacts which are supported by the insulator and arranged at predetermined intervals in a direction orthogonal to an insertion direction of the connecting object into the connecting-object insertion groove.

It is desirable for the first resilient deformable portion and the second resilient deformable portion to be shaped like a substantially S-shaped as a whole in a side view.

According to the present invention, upon the connecting object being inserted into the connecting-object insertion groove to an intermediate position, the trace (conductive trace) of the circuit pattern, which is formed on one side of the connecting object, comes into contact with the first contact protrusion of the contact. From this state, sliding movement of the trace of the circuit pattern on the first contact protrusion of the contact by making the connecting object fully inserted into the connecting-object insertion groove causes minute foreign particles adhered to the surface of the trace of the circuit pattern to be cleaned (swept off) by the first contact protrusion of the contact. Subsequently, the second contact protrusion comes into contact with this cleaned portion of the trace of the circuit pattern.

The second resilient deformable portion of the contact of the connector according to the present invention has a shape so as to extend toward the innermost end of the connecting-object insertion groove from the first contact protrusion and thereafter extending back toward the first contact protrusion rather than a shape that flatly extends toward the innermost end of the connecting-object insertion groove from the first contact protrusion, and accordingly, a large spring length of the second resilient deformable portion can be achieved. This improves the followability of the second resilient deformable portion with respect to the connecting object. Moreover, since the distance from the first contact protrusion to the second contact protrusion (in the insertion/removal direction of the connecting object) is short, even though the spring length of the second resilient deformable portion is large, the amount of deviation of the displacement of the second contact protrusion from a predetermined value (design value) does not become great even if the first contact protrusion is displaced in the contacting direction thereof by a greater amount than a predetermined value (design value) when the connecting object is inserted into the insulator. Therefore, the second contact protrusion is less susceptible to displacements of the first contact protrusion, and accordingly, when the first contact protrusion comes into contact with the trace of the circuit pattern, there is little possibility of the second contact protrusion being deformed to a position where it becomes in non-contact with the trace of the circuit pattern.

Therefore, the possibility of the contact condition between each of the first contact protrusion and the second contact protrusion and the trace of the circuit pattern becoming unstable is low, and each of the first contact protrusion and the second contact protrusion can be made to contact securely with the trace of the circuit pattern.

In addition, since the second resilient deformable portion has a shape extending toward the innermost end of the connecting-object insertion groove from the first contact protrusion and thereafter extending back toward the first contact protrusion, the contact and the connector can be reduced in size in the insertion direction of the connecting object (into the insulator) even in the case where the spring length of the second resilient deformable portion is made long.

Additionally, since the second contact protrusion comes into contact with a cleaned portion of the trace of the circuit pattern, the possibility of poor electrical contact occurring between the second contact protrusion and the connecting object is low.

Additionally, since the connecting object and the contact come in contact with each other at two points, even if the contact state of one of the two contact points is temporarily (momentarily) released by vibrations applied to the connector, there is a possibility of the contact state of the other contact point being maintained, which improves contact reliability compared with the case where the connecting object and the contact come in contact with each other at a single point.

### BRIEF DESCRIPTION OF THE DRAWINGS

FIG. 1 is a front perspective view of an embodiment of a connector according to the present invention and an FPC as a connecting object which is to be connected to the connector, viewed obliquely from above;

FIG. 2 is an exploded front perspective view of the connector, viewed obliquely from above;

FIG. 3 is an exploded rear perspective view of the connector, viewed obliquely from below;

FIG. 4 is a front elevational view of the connector;

FIG. 5 is a cross sectional view taken along the line V-V shown in FIG. 4;

FIG. 6 is a cross sectional view taken along the line VI-VI shown in FIG. 4;

FIG. 7 is an enlarged front perspective view of a signal contact of the connector, viewed from above;

FIG. 8 is an enlarged front perspective view of a signal contact of the connector, viewed from below;

FIG. 9 is a view similar to that of FIG. 6, showing the connector and the FPC when the FPC is inserted into a connecting-object insertion groove of the connector to an intermediate position;

FIG. 10 is a cross sectional view taken along the line X-X shown in FIG. 4, showing the connector and the FPC when the FPC is inserted into the connecting-object insertion groove of the connector to the intermediate position;

FIG. 11 is a view similar to that of FIG. 1, showing the connector and the FPC when the FPC is fully inserted into the connecting-object insertion groove of the connector;

FIG. 12 is a view similar to that of FIG. 6, showing the connector and the FPC when the FPC is fully inserted into the connecting-object insertion groove of the connector;

FIG. 13 is a view similar to that of FIG. 10, showing the connector and the FPC when the FPC is fully inserted into the connecting-object insertion groove of the connector; and

FIG. 14 is a schematic diagram of a comparative example, showing a contact state between an FPC and a contact.

### BRIEF DESCRIPTION OF THE PREFERRED EMBODIMENT

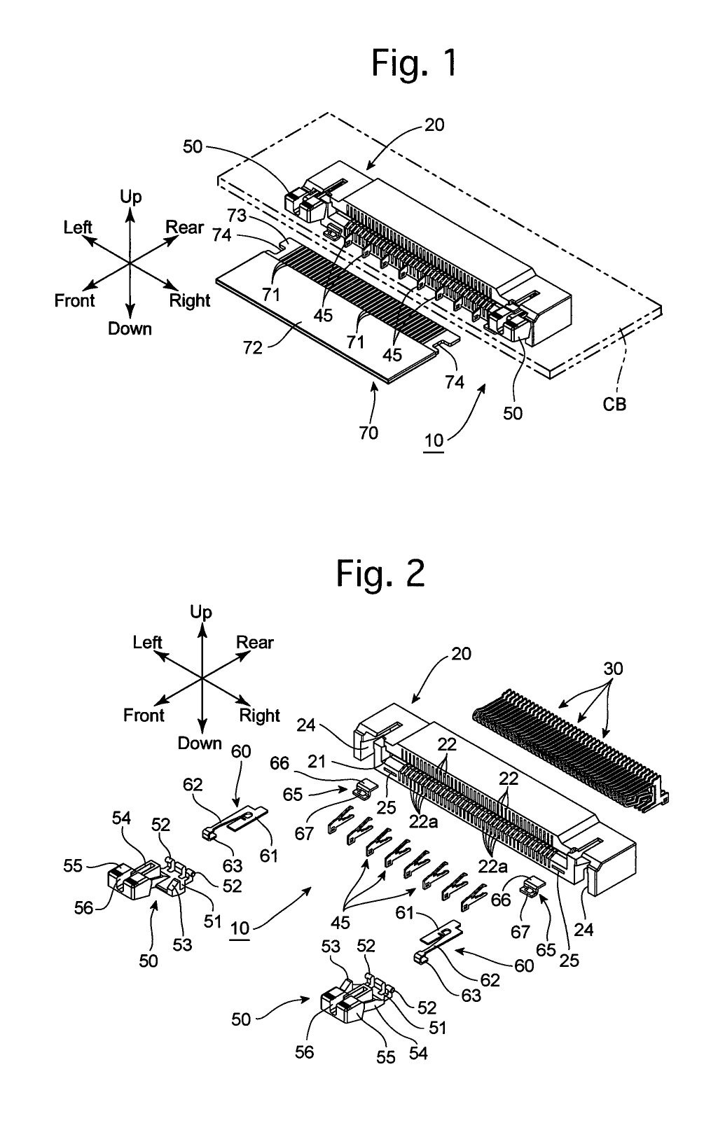

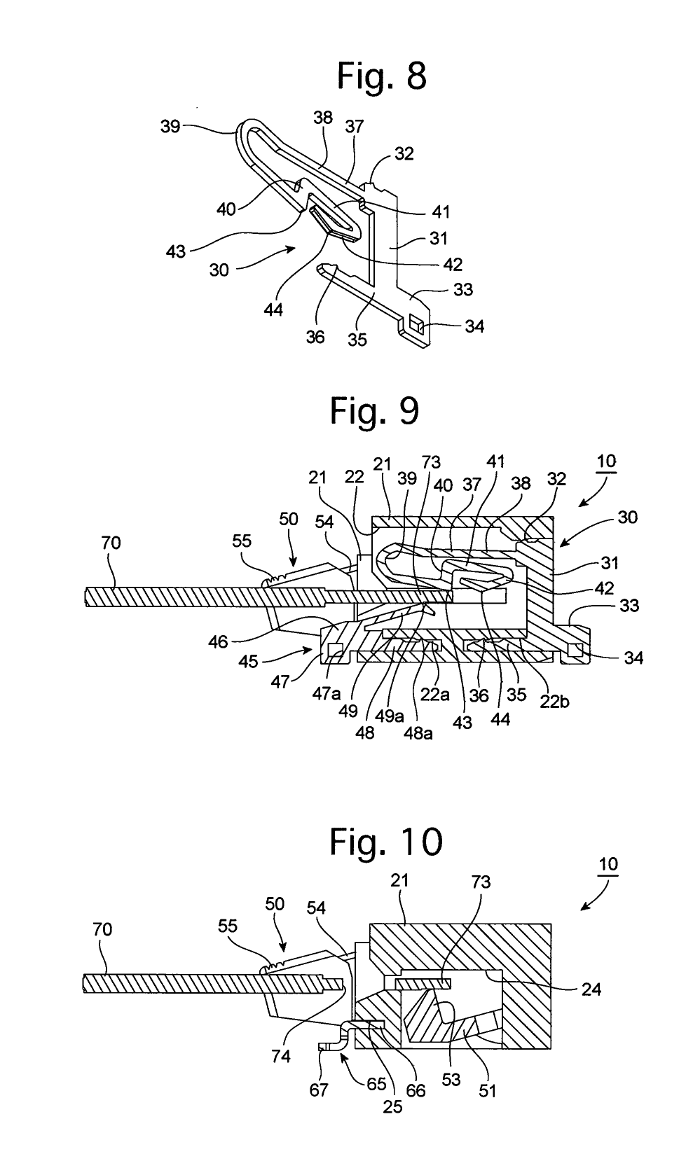

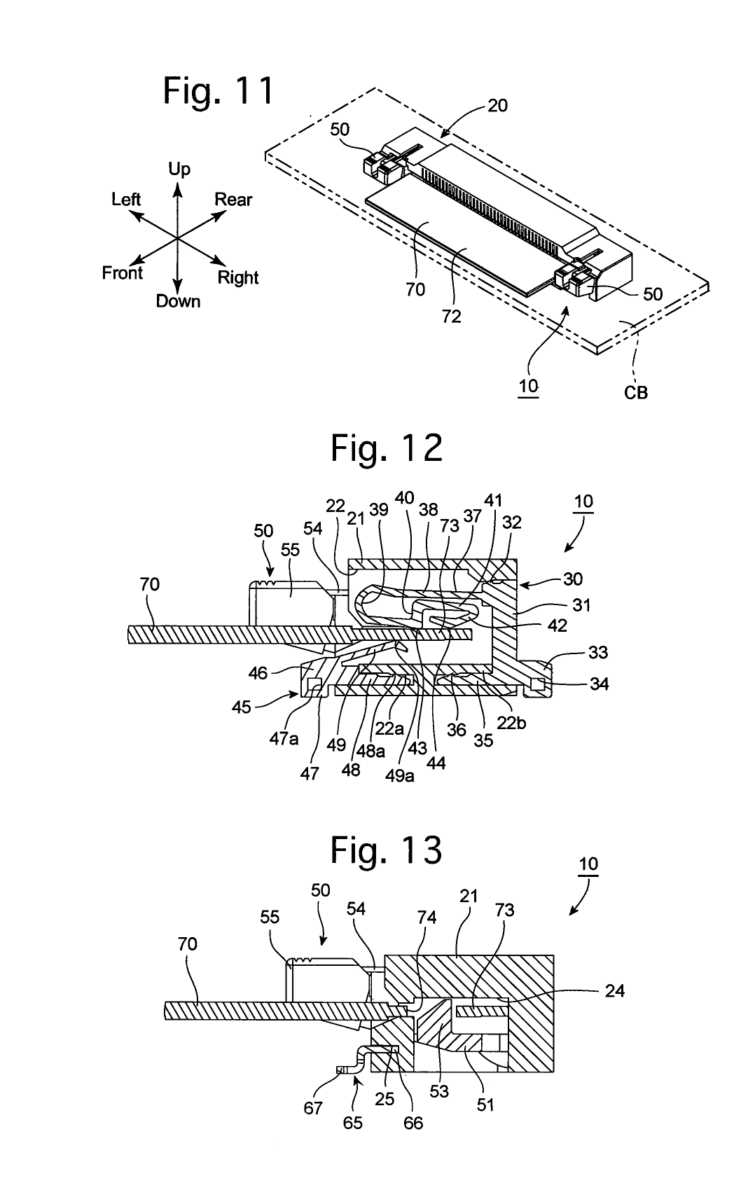

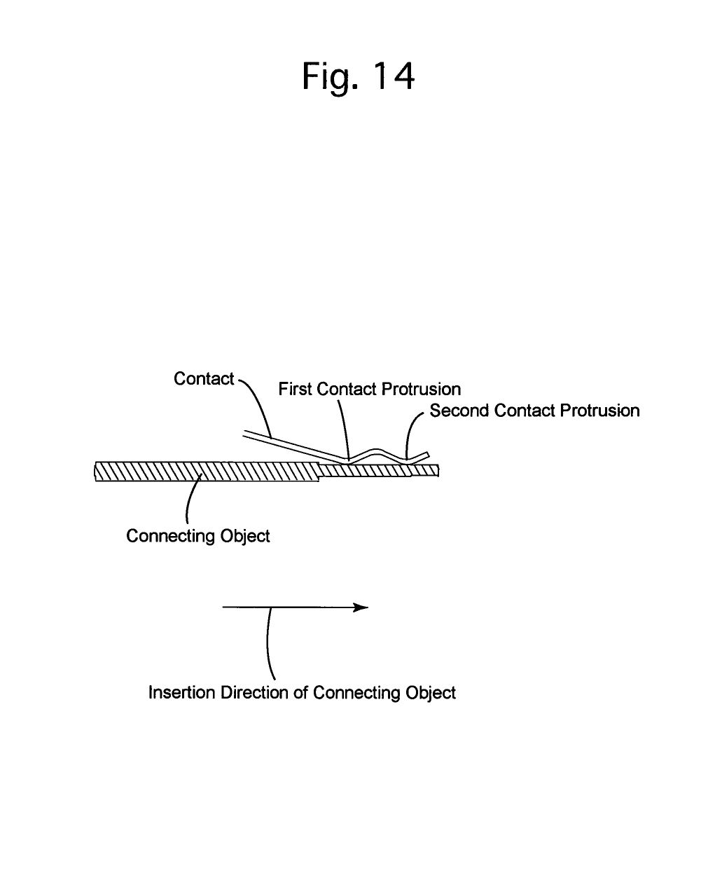

An embodiment of a connector according to the present invention will be hereinafter discussed with reference to FIGS. 1 through 13. In the following descriptions, forward and rearward directions, leftward and rightward directions, and upward and downward directions of the connector 10 are determined with reference to the directions of the double-headed arrows shown in the drawings.

The connector 10 is applicable to, e.g., a car navigation system which is installed in or on an instrument panel provided on the front of a vehicle interior, or a multifunctional printer in which a copier and a facsimile are incorporated. The connector 10 is provided with an insulator 20, forty signal contacts 30, eight ground contacts 45, two lock members 50, two lock biasing springs 60 and two fixing brackets 65, which constitute major elements of the connector 10.

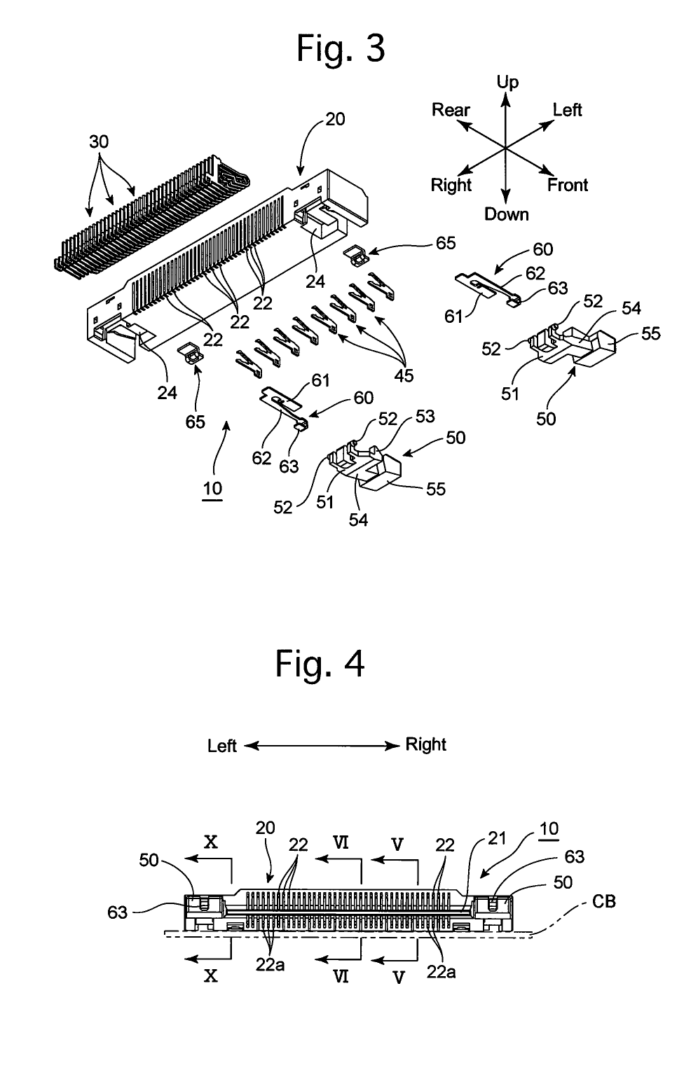

The insulator 20 is formed from electrical-insulative and heat-resistant synthetic resin by injection molding. The insulator 20 is provided on the front thereof with a connecting-object insertion groove 21 which is recessed rearward and has substantially the same width as an FPC (connecting object) 70. The insulator 20 is provided at the front thereof with a total of forty contact insertion grooves 22 which are formed to elongate in the rearward direction and arranged at predetermined intervals in the leftward/rightward direction. Each contact insertion groove 22 extends through a rear wall of the insulator 20 in the forward/rearward direction (see FIGS. 3, 5, 6, etc.). The insulator 20 is provided at the front of a bottom plate portion thereof with a total of forty ground contact fixing grooves 22a which are formed to elongate in the rearward direction in the bottom plate portion, and the front ends of the forty ground contact fixing grooves 22a are communicatively connected with the front ends of the corresponding forty contact insertion grooves 22, respectively. In addition, the insulator 20 is provided at the rear of the bottom plate portion thereof with a total of forty signal contact fixing grooves 22b which are formed to elongate in the forward direction in the bottom plate portion, and the rear ends of the forty signal contact fixing grooves 22b are communicatively connected with the rear ends of the corresponding forty contact insertion grooves 22, respectively. The positions of the forty ground contact fixing grooves 22a are coincident with the positions of the forty signal contact fixing grooves 22b in the leftward/rightward direction, respectively. The insulator 20 is provided, at the left and right ends of the front thereof, with two (left and right) lock member attachment grooves 24, respectively, which are recessed rearward and open at the lower ends thereof. The inner sides of the two lock member attachment grooves 24 (specifically a right half of the left lock member attachment groove 24 and a left half of the right lock member attachment groove 24) are communicatively connected with both the left and right ends of the connecting-object insertion groove 21, respectively. The insulator 20 is provided on the front thereof with a pair of left and right fixing-bracket attachment grooves 25 which are formed to elongate in the rearward direction.

The total of forty signal contacts (contacts) 30 are each formed from a thin plate made of a spring copper alloy (e.g., phosphor bronze, beryllium copper or titanium copper) or a spring Corson-copper alloy and formed into the shape shown in the drawings with a progressive die (progressive stamping die), and is coated with firstly nickel (Ni) plating as base plating and subsequently gold (Au) plating as finish plating.

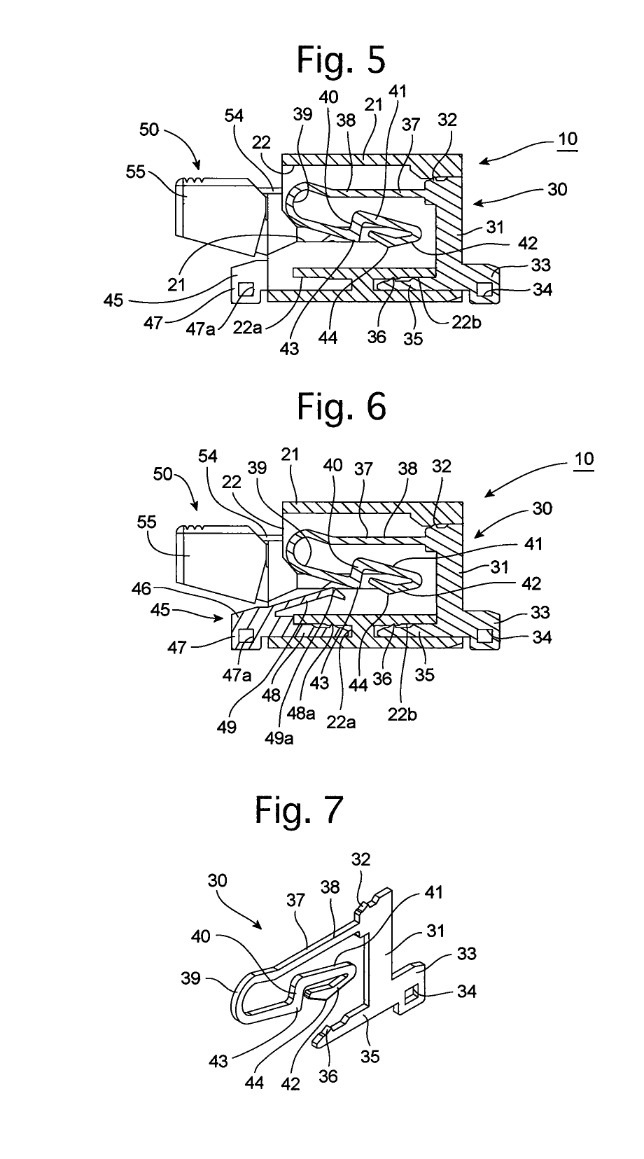

As shown in FIGS. 5 through 8, each signal contact 30 is provided with a base end portion 31, a tail portion 33, a fixing projection 35 and a resilient contact portion 37. The base end portion 31 extends in the vertical direction, the tail portion 33 projects rearward from the lower end of the base end portion 31, the fixing projection 35 extends forward from the lower end of the base end portion 31, and the resilient contact portion 37 extends forward from an upper part of the base end portion 31. Each signal contact 30 is provided at the upper end of the base end portion 31 with a lock projection 32 which projects upward and is provided on a top surface of the fixing projection 35 with a lock projection 36 which projects upward. A rectangular hole 34 which is square in a side view is formed through the tail portion 33 of each signal contact 30 as a through-hole.

The resilient contact portion 37 of each signal contact 30 is provided with a forward-extending projecting portion (toward-open-end extended portion) 38, a curved extending portion (first resilient deformable portion) 39, an upward extending portion (first-contact-protrusion end portion/an element of a second resilient deformable portion) 40, a rearward extending portion (intermediate portion/an element of the second resilient deformable portion) 41 and a turned-back end portion (an element of the second resilient deformable portion) 42. The forward-extending projecting portion 38 extends linearly forward from the base end portion 31. The curved extending portion 39 firstly extends obliquely forward and upward from the front end of the forward-extending projecting portion 38 and subsequently extends obliquely rearward downward after being curved downward. The upward extending portion 40 extends upward toward the forward-extending projecting portion 38 from the rear end of the curved extending portion 39, the rearward extending portion 41 obliquely extends rearward downward from the upper end of the upward extending portion 40, and the turned-back end portion 42 extends forward from the rear end of the rearward extending portion 41. In addition, each signal contact 30 is provided at the rear end of the curved extending portion 39 with a first contact protrusion 43 which protrudes downward and provided in the vicinity of the tip (front end) of the turned-back end portion 42 with a second contact protrusion 44 which protrudes downward. As shown in the drawings, the upward extending portion 40 is greater in width than the forward-extending projecting portion 38, the curved extending portion 39 and the rearward extending portion 41, thus having greater rigidity than these portions.

The forty signal contacts 30 are inserted into the forty contact insertion grooves 22 of the insulator 20 from the rear, respectively. As shown in FIGS. 5 and 6, the fixing projection 35 of each signal contact 30 is inserted into the associated signal contact fixing groove 22b, and the base end portion 31 of each signal contact 30 is positioned at the rear end of the associated contact insertion groove 22. The lock projection 36 of each signal contact 30, which projects from the fixing projection 35, digs into the ceiling surface of the associated signal contact fixing groove 22b, and the lock projection 32 of the base end portion 31 of each signal contact 30 digs into the rear end of the ceiling surface of the associated contact insertion groove 22, so that the base end portion 31 and the fixing projection 35 of each signal contact 30 are fixed to the insulator 20 (to the associated contact insertion groove 22 and the associated signal contact fixing groove 22b, respectively) when the forty signal contacts 30 are inserted into the forty contact insertion grooves 22, respectively.

When each signal contact 30 is inserted into the associated contact insertion groove 22, the resilient contact portion 37 is in a free state unless the FPC 70 is inserted into the insulator 20 (the connecting-object insertion groove 21). When the resilient contact portion 37 of each signal contact 30 is in a free state, each portion of the resilient contact portion 37 lies in a plane orthogonal to the leftward/rightward direction. In addition, when each signal contact 30 is in a free state, the lower end of the second contact protrusion 44 is positioned slightly further downward than the lower end of the first contact protrusion 43 (see FIGS. 5 and 6). Additionally, when each signal contact 30 is in a free state, the first contact protrusion 43 and the tip (front end) of the turned-back end portion 42 of each signal contact 30 are positioned inside the connecting-object insertion groove 21. Additionally, the tip (front end) of the turned-back end portion 42 is positioned further upward than the lower end of the first contact protrusion 43 in each signal contact 30.

The total of eight ground contacts 45 are each formed from a thin plate made of a spring copper alloy (e.g., phosphor bronze, beryllium copper or titanium copper) or a spring Corson-copper alloy and formed into the shape shown in the drawings with a progressive die (progressive stamping die), and is coated with firstly nickel (Ni) plating as base plating and subsequently gold (Au) plating as finish plating.

As shown in FIG. 6 and other drawings, each ground contact 45 is provided with a base end portion 46, a tail portion 47, a fixing projection 48 and a resilient deformable portion 49. The tail portion 47 extends downward from the base end portion 46, the fixing projection 48 extends rearward from the base end portion 46, and the resilient deformable portion 49 extends obliquely rearward upward from the base end portion 46. A rectangular hole 47a which is square in a side view is formed though the tail portion 47 of each ground contact 45 as a through-hole. Each ground contact 45 is provided, on an upper surface thereof in the vicinity of the tip of the fixing projection 48, with a lock projection 48a which projects upward, and is provided in the vicinity of the tip of the resilient deformable portion 49 with a contact projection 49a which projects upward.

The eight ground contacts 45 are inserted into eight contact insertion grooves 22 of the forty contact insertion grooves 22 from the front, respectively. As shown in FIG. 6, the fixing projection 48 of each ground contact 45 is inserted into the associated ground contact fixing groove 22a, and the lock projection 48a of each ground contact 45, which projects from the fixing projection 48, digs into the ceiling surface of the associated ground contact fixing groove 22a. Therefore, the eight ground contacts 45 are fixed to the insulator 20 (to the associated ground contact fixing grooves 22a) when inserted into the eight contact insertion grooves 22, respectively. In addition, when the eight ground contacts 45 are installed to the insulator 20, the resilient deformable portions 49 thereof are positioned immediately below the curved extending portions 39 of the associated eight signal contacts 30, respectively, to thereby form a clearance in the vertical direction between the contact projection 49a of the resilient deformable portion 49 of each of the eight ground contacts 45 and the curved extending portion 39 of the associated signal contact 30. Additionally, when each ground contact 45 is in a free state, the contact projection 49a of the resilient deformable portion 49 thereof is positioned inside the connecting-object insertion groove 21.

Each of the pair of left and right lock members 50 is formed from heat-resisting synthetic resin by injection molding using a metal mold. Each lock member 50 is provided at the rear end thereof with a base plate portion 51 having the shape of a substantially flat plate. Each lock member 50 is provided, on a portion thereof which projects upward from the rear end of the base plate portion 51, with a pair of left and right rotational shafts 52 that are columnar in shape and coaxial with each other. Each lock member 50 is provided, on the inner side of the front end of the base plate portion 51, with a lock pawl 53 which projects upward and the front surface of which is formed as an inclined surface. Each lock member 50 is provided with an arm portion 54 which extends obliquely forward upward from the outer side of the front end of the base plate portion 51. The front end of the arm portion 54 is formed as an operating portion 55 having a greater width (in the leftward/rightward direction) than the rear of the same arm portion 54, and a receptive groove 56 is formed in the upper surface of the arm portion 54.

The left and right lock members 50 are installed in the left and right lock member attachment grooves 24, respectively, by inserting the base plate portion 51 and the rear of the arm portion 54 of each lock member 50 into the associated lock member attachment groove 24 and making the pair of left and right rotational shafts 52 of each lock member 50 rotatably supported by a bearing portion (not shown) formed in an inner surface of the associated lock member attachment groove 24. When each lock member 50 is installed in the associated lock member attachment groove 24, the operating portion 55 of the lock member 50 projects forward from the front of the insulator 20, and the lock pawl 53 of the lock member 50 is positioned in an internal portion (which is communicatively connected with both the left and right ends of the connecting-object insertion groove 21) of the associated lock member attachment groove 24.

Each lock member 50 is rotatable between a locked position (the position shown in FIGS. 1, 5, 6, etc.), at which the upper surface of the operating portion 55 becomes substantially parallel to the upper surface of the insulator 20, and an unlocked position (the position shown in FIGS. 9 and 10), at which the arm portion 54 is rotated downward from the locked position about the associated pair of rotational shafts 52.

Each of the two lock biasing springs 60 is a product formed of a metal plate by press molding. Each lock biasing spring 60 is provided with a stationary portion 61 having the shape of a flat plate, a resilient deformable portion 62 which extends obliquely forward upward from an outer edge of the stationary portion 61, and a front engaging portion 63 which is formed at the front end of the resilient deformable portion 62.

The two lock biasing springs 60 are fixed to the two lock member attachment grooves 24, respectively, by inserting the rear of each lock biasing spring 60 into an upper portion of the associated lock member attachment groove 24 and inserting the stationary portion 61 of each lock biasing spring 60 into a support groove formed on an inner surface of the lock member attachment groove 24. The front engaging portions 63 of the two lock biasing springs 60 are engaged in the receptive grooves 56 of the two lock members 50 from above to thereby become integral with the two lock members 50, respectively. In addition, since the resilient deformable portion 62 of each lock biasing spring 60 is slightly resiliently deformed downward from a free state, each lock member 50 is held in the aforementioned locked position by an upward biasing force produced by the resilient deformable portion 62 of the associated lock biasing spring 60 when no external force (except for biasing force of the lock biasing spring 60) is applied to the lock biasing spring 60.

Each of the two fixing brackets 65 is a product formed of a metal plate by press molding. Each fixing bracket 65 is provided with a stationary lug 66 in the shape of a flat plate and a tail portion 67 which extends forward after extending downward from the front edge of the stationary lug 66.

The left and right fixing brackets 65 are fixed to the insulator 20 by inserting the stationary lugs 66 into the pair of left and right fixing-bracket attachment grooves 25 from the front, respectively.

In order to mount the connector 10 having the above described structure onto the upper surface (circuit formation surface) of a circuit board CB (shown by two-dot chain lines in FIGS. 1,4 and 11), the upper surface of the insulator 20 is vacuum held using a suction device (not shown) located above the connector 10. By moving the suction device, the tail portion 33 of each signal contact 30 is placed onto a circuit pattern (not shown), to which a predetermined amount of soldering paste has been applied, of the circuit board CB, and the tail portion 47 of each ground contact 45 and the tail portion 67 of each fixing bracket 65 are placed onto a ground pattern (not shown), to which a predetermined amount of soldering paste has been applied, of the circuit board CB. Subsequently, after the suction device, the suction/vacuum force of which has been turned OFF, is retracted to a position above the connector 10, each of the applied soldering paste portions is heated and melted in a reflow oven, whereby each tail portion 33 is soldered to the aforementioned circuit pattern while each tail portion 47 and each tail portion 67 are soldered to the aforementioned ground pattern.

When the tail portion 33 of each signal contact 30 is soldered to the circuit pattern, a part of the soldering is solidified in the rectangular hole 34, so that the peel strength of the tail portion 33 of each signal contact 30 on the circuit pattern is great. Likewise, when the tail portion 47 of each ground contact 45 is soldered to the ground pattern, a part of the soldering is solidified in the rectangular hole 47a, so that the peel strength of the tail portion 47 of each ground contact 45 on the ground pattern is also great.

The process of connecting and disconnecting the FPC (flexible printed circuit) 70 to and from the connector 10 and operations of the connector 10 when the FPC 70 is connected and disconnected to and from the connector 10 will be discussed hereinafter.

The FPC 70 has a multi-layered structure made up of a plurality of thin films which are bonded together. The FPC 70 is provided on the top surface thereof with a circuit pattern having a total of forty traces (conductive traces) 71 which are formed to extend linearly in the longitudinal direction of the FPC 70 and arranged at predetermined intervals in the leftward/rightward direction. The FPC 70 is provided with an insulating cover layer 72 which covers the upper surface of the FPC 70 except both ends (with respect to the longitudinal direction of the FPC 70) of each trace 71 of the circuit pattern. The FPC 70 is provided on the lower surface thereof with a wide ground pattern (not shown; having substantially the same width as the entirety of the forty traces 71) which extends parallel to the forty circuit traces 71. The FPC 70 is provided with an insulating cover layer (not shown) which covers the lower surface of the FPC 70 except both ends of the ground pattern. As shown in the drawings, the rear end of the FPC 70 (and the front end thereof not shown in the drawings) is formed as a rigid end portion 73 which is more rigid than the remaining part of the FPC 70. The rear end (and the front end) of each trace 71 is formed on the upper surface of the rigid end portion 73, while the rear end (and the front end) of the ground pattern is formed on the lower surface of the rigid end portion 73. In addition, the rigid end portion 73 is provided at laterally opposite side edges thereof with a pair of lock recesses 74, respectively.

As shown in FIG. 1, upon the rear end (the rigid end portion 73) of the FPC 70 being inserted into the connecting-object insertion groove 21 from the front of the insulator 20 (see FIGS. 9 and 10), the rigid end portion 73 slides rearward in the inside of the insulator 20 along the connecting-object insertion groove 21.

Upon the FPC 70 being inserted to an intermediate position of the connecting-object insertion groove 21 as shown in FIGS. 9 and 10, the resilient deformation portion 49 of each ground contact 45 is resiliently deformed downward by the contact of the ground pattern, which is formed on the lower surface of the rigid end portion 73, with the contact projection 49a, while the curved extending portion 39 and the forward-extending projecting portion 38 of each signal contact 30 are resiliently deformed by contact of the rear end (upper surface thereof) of each trace 71 with the first contact protrusion 43 of the associated signal contact 30.

Additionally, as shown in FIG. 10, the rear surfaces of both the left and right ends of the rigid end portion 73 depress the lock pawls 53 of the left and right lock members 50 downward in the left and right lock member attachment grooves 24, respectively, so that each lock member 50 which has been positioned in the locked position rotates to the unlocked position while resiliently deforming the resilient deformable portion 62 of the associated lock biasing spring 60 downward.

Thereafter, upon the rigid end portion 73 being fully engaged in the connecting-object insertion groove 21 by further moving the FPC 70 rearward from the state shown in FIGS. 9 and 10, the left and right lock recesses 74 are positioned immediately above the lock pawls 53 of the left and right lock members 50 (the engagement between the rear ends of the rigid end portions 73 and the lock pawls 53 of the left and right lock members 50 is released), respectively, so that each lock member 50 that is biased upward by the resilient deformable portion 62 of the associated lock biasing spring 60 rotates back to the locked position. Thereupon, the lock pawl 53 of each lock member 50 is engaged in the associated lock recess 74 from below (see FIG. 13). Therefore, even if a force urging the FPC 70 to be pulled forward is exerted on the FPC 70, the FPC 70 (the rigid end portion 73) does not come out forward from the connecting-object insertion groove 21.

In addition, upon the rigid end portion 73 being fully engaged in the connecting-object insertion groove 21, the rear end of each trace 71 of the FPC 70 slides rearward on the first contact protrusion 43 of the associated signal contact 30, so that minute foreign particles (e.g., dust) adhered to the surface of each trace 71 are cleaned (swept) by the first contact protrusion 43 of the associated signal contact 30. Subsequently, the second contact protrusion 44 of each signal contact 30 comes in contact with a cleaned (swept) portion on the surface of the associated trace 71. At this time, a portion (second resilient deformable portion) of each signal contact 30 which includes the upward extending portion 40, the rearward extending portion 41 and the turned-back end portion 42 is resiliently deformed, producing a downward resilient force, and the second contact protrusion 44 of the same signal contact 30 is pressed against the associated trace 71 by this downward resilient force. However, rather than the aforementioned portion of each signal contact 30 (which includes the upward extending portion 40, the rearward extending portion 41 and the turned-back end portion 42) having a shape that flatly extends rearward from the first contact protrusion 43, the aforementioned portion of each signal contact 30 has a shape that firstly extends upward from the first contact protrusion 43, subsequently extends rearward and thereafter extends forward; accordingly, the spring length of the aforementioned portion of each signal contact 30 that includes the upward extending portion 40, the rearward extending portion 41 and the turned-back end portion 42 is great. Therefore, the portion of each signal contact 30 that includes the upward extending portion 40, the rearward extending portion 41 and the turned-back end portion 42 has favorable followability (capable of obtaining a sufficient resilient displacement) with respect to the FPC 70 and does not easily deform plastically. Moreover, since the distance from the first contact protrusion 43 to the second contact protrusion 44 in the forward/rearward direction is short even though the spring length of the portion including the upward extending portion 40, the rearward extending portion 41 and the turned-back end portion 42 is great, the amount of deviation of the displacement of the second contact protrusion 44 from a design value does not become great even if the displacement of the first contact protrusion 43 in the vertical direction deviates from a predetermined value (design value) (even if the first contact protrusion 43 is displaced in the vertical direction by a greater amount than a predetermined value) when the FPC 70 is inserted into the insulator 20. Furthermore, since the upward extending portion 40 has greater rigidity than the forward-extending projecting portion 38, the curved extending portion 39 and the rearward extending portion 41, the upward extending portion 40 (and the rearward extending portion 41 and the turned-back end portion 42) of each signal contact 30 does not easily deform even if the first contact protrusion 43 receives a reaction force from the associated trace 71. Therefore, when the first contact protrusion 43 of each signal contact 30 comes into contact with the associated trace 71, there is little possibility of the second contact protrusion 44 of each signal contact 30 being deformed to a position where it becomes in non-contact with the associated trace 71 because the second contact protrusion 44 is less susceptible to displacements of the first contact protrusion 43.

Likewise, a portion of each signal contact 30 has a shape firstly extending forward from rear and subsequently extending obliquely rearward downward after being curved downward, rather than the portion of each signal contact 30 (which includes the forward-extending projecting portion 38 and the curved extending portion 39) flatly extending forward or rearward; accordingly, the spring length of the aforementioned portion of each signal contact 30 that includes the forward-extending projecting portion 38 and the curved extending portion 39 is great. Therefore, the portion of each signal contact 30 that includes the forward-extending projecting portion 38 and the curved extending portion 39 is favorable in followability (capable of obtaining a sufficient resilient displacement) with respect to the FPC 70 and does not easily deform plastically. Therefore, there is little possibility of the first contact protrusion 43 of each signal contact 30 being spaced from the associated trace 71 when the second contact protrusion 44 of the same signal contact 30 receives a reaction force from the associated trace 71.

Therefore, the possibility of the contacting state between each of the first contact protrusion 43 and the second contact protrusion 44 and the associated trace 71 becoming unstable is low, and each of the first contact protrusion 43 and the second contact protrusion 44 can be made to contact securely with the associated trace 71, which makes it possible to reliably establish continuity between the FPC 70 and the circuit board CB.

In addition, since the aforementioned portion of each signal contact 30 which includes the upward extending portion 40, the rearward extending portion 41 and the turned-back end portion 42, has a shape that firstly extends upward (at the upward extending portion 40) and subsequently extends rearward (at the rearward extending portion 41), rather than the aforementioned portion of each signal contact 30 having a shape that flatly extends rearward, the distance between the first contact protrusion 43 and the second contact protrusion 44 in the forward/rearward direction can be short, and the connector 10 can be miniaturized in the forward/rearward direction. In addition, since the connector 10 is formed having such a shape, in each signal contact 30, the upper surface of the turned-back end portion 42 does not come in contact with the lower surface of the rearward extending portion 41 when the turned-back end portion 42 is resiliently deformed upward by contact of the associated trace 71 with the second contact protrusion 44. Namely, there is no possibility of the biasing force of the turned-back end portion 42 of each signal contact 30 that biases the second contact protrusion 44 downward becoming excessively great by the rearward extending portion 41 and the turned-back end portion 42 interfering with each other.

Additionally, in each signal contact 30, the tip (front end) of the turned-back end portion 42 is positioned further upward than the first contact protrusion 43, and the lower end of the second contact protrusion 44 is positioned further downward than the first contact protrusion 43. Therefore, when the FPC 70 is inserted into the connecting-object insertion groove 21, there is no possibility of the turned-back end portion 42 buckling by the tip of the turned-back end portion 42 contacting the rear end surface of the FPC 70, so that the second contact protrusion 44 of each signal contact 30 can be made to reliably contact the associated trace 71.

Additionally, since the aforementioned portion of each signal contact 30 which includes the upward extending portion 40, the rearward extending portion 41 and the turned-back end portion 42, has a shape that firstly extends upward from the first contact protrusion 43, subsequently extends rearward and thereafter extends forward, rather than the aforementioned portion of each signal contact 30 having a shape that flatly extends rearward from the first contact protrusion 43, each signal contact 30 and the connector 10 can be reduced in size in the forward/rearward direction even in the case where the spring length of the aforementioned portion (including the upward extending portion 40, the rearward extending portion 41 and the turned-back end portion 42) is formed long.

Additionally, since each signal contact 30 comes into contact with the FPC 70 (specifically the associated trace 71) at two points, i.e., the first contact protrusion 43 and the second contact protrusion 44, even if the contact state of one of the two contact points (e.g., the first contact protrusion 43) is temporarily (momentarily) released by vibrations of the object (e.g., automobile) in which the connector 10 is incorporated, there is a possibility of the contact state of the other contact point (e.g., the second contact protrusion 44) being maintained, which makes it possible to obtain high contact reliability.

To disconnect the FPC 70 and the connector 10 from each other, an operator manually depresses the operating portions 55 of the left and right lock members 50. Thereupon, the lock pawls 53 of the left and right lock members 50 are disengaged downward from the left and right lock recesses 74, respectively, which allows the operator to pull out the FPC 70 easily from the connector 10 (specifically from the connecting-object insertion groove 21) by manually pulling the FPC 70 forward from the connector 10. If the operator releases his or her hand from the lock members 50 after pulling the FPC 70 out from the connector 10, each lock member 50 rotates and returns to the locked position by the rotational biasing force of the associated lock spring biasing spring 60, so that the connector 10 automatically returns to the state shown in FIGS. 1, 5 and 6.

Although the present invention has been described based on the above illustrated embodiment of the connector, the present invention is not limited solely to this particular embodiment; various modifications to the above illustrated embodiment of the connector is possible.

For instance, it is possible to install each signal contact 30 into the insulator 20 with each signal contact 30 positioned upside down and to make the first contact protrusion 43 and the second contact protrusion 44 of each signal contact 30 come in contact with the associated trace of a circuit pattern formed on the lower surface of an FPC. In this case, it is possible to omit the forward-extending projecting portion 38 from each signal contact 30.

The thin plate-shaped connecting object is not limited solely to an FPC; for instance, the thin plate-shaped connecting object can be any other cable such as an FFC (flexible flat cable).

The eight ground contacts 45 can be omitted from the connector 10.

It is possible to arrange, in a zigzag manner, the plurality of signal contacts 30 and a plurality of another type of contacts (not shown), each of which has a portion longitudinally symmetrical to the resilient contact portion 37 of each signal contact 30, by locating one contact of the aforementioned another type in between every two adjacent signal contacts 30 while installing each contact of the aforementioned another type to the insulator 20 from front.

In addition, the plurality of signal contacts 30 and the aforementioned plurality of another type of contacts can each be made by bending a metal strip obtained by stamping a thin metal plate as a base material. In this case, the plurality of signal contacts 30 and the aforementioned plurality of another type of contacts will be resiliently deformable in the direction of the plate thickness of the aforementioned thin metal plate.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A connector comprising:
an insulator having a connecting-object insertion groove, into which a connecting object having a thin plate shape can be inserted and removed through an open end of said connecting-object insertion groove; and
at least one contact which is supported by said insulator to be contactable with a trace of a circuit pattern formed on one side of said connecting object,
wherein said contact comprises:
a first resilient deformable portion, a part of which extends toward an innermost end of said connecting-object insertion groove from said open end;
a first contact protrusion which protrudes from said first resilient deformable portion and comes into sliding contact with said trace when said connecting object is inserted into said connecting-object insertion groove;
a second resilient deformable portion which extends toward said innermost end of said connecting-object insertion groove from said first contact protrusion and thereafter extends back toward said first contact protrusion; and
a second contact protrusion which protrudes from said second resilient deformable portion, is positioned closer to said innermost end of said connecting-object insertion groove than said first contact protrusion, and comes into contact with a portion of said trace which is positioned closer to said innermost end of said connecting-object insertion groove than another portion of said trace with which said first contact protrusion is in contact when said connecting object is inserted into said connecting-object insertion groove.

2. The connector according to claim 1, wherein said contact comprises a toward-open-end extended portion which extends toward said open end from said innermost end side, and
wherein said first resilient deformable portion extends toward said open end from an end of said toward-open-end extended portion and thereafter extends toward said innermost end so as to face said toward-open-end extended portion in a thickness direction of said connecting object.

3. The connector according to claim 2, wherein said second resilient deformable portion comprises:
a first-contact-protrusion end portion which extends toward said toward-open-end extended portion from said first contact protrusion;
an intermediate portion which extends toward said innermost end from said first-contact-protrusion end portion and faces said toward-open-end extended portion in said thickness direction of said connecting object; and
a turned-back end portion which extends back toward said first contact protrusion from an end of said intermediate portion to face said intermediate portion in said thickness direction of said connecting object, wherein said second contact protrusion protrudes from said turned-back end portion.

4. The connector according to claim 3, wherein said first-contact-protrusion end portion is greater in rigidity than said first contact protrusion and said intermediate portion.

5. The connector according to claim 3, wherein said first-contact-protrusion end portion is greater in width than that of said first resilient deformable portion and that of said intermediate portion.

6. The connector according to claim 1, wherein said at least one contact comprises a plurality of contacts which are supported by said insulator and arranged at predetermined intervals in a direction orthogonal to an insertion direction of said connecting object into said connecting-object insertion groove.

7. The connector according to claim 1, wherein said first resilient deformable portion and said second resilient deformable portion are shaped like a substantially S-shaped as a whole in a side view.
